(19) United States
(12) Patent Application Publication
(10) Pub. No.: US 2020/0247076 A1
(43) Pub. Date: Aug. 6, 2020

(54) TIRE-BUFFING SYSTEM CONSTITUTED BY A ROBOTIZED ARM WITH ANGULAR INTERPOLATION MOVEMENTS

(71) Applicant: Lucas Möller, Sao Leopoldo (BR)

(72) Inventor: Lucas Möller, Sao Leopoldo (BR)

(21) Appl. No.: 16/838,464

(22) Filed: Apr. 2, 2020

Related U.S. Application Data
(63) Continuation-in-part of application No. 14/386,858, filed on Sep. 22, 2014.

(30) Foreign Application Priority Data
Mar. 26, 2012 (BR) 10 2012 006723 4

(51) Int. Cl. B29D 30/54; B24B 5/36; B24B 49/04; B25J 11/00

(52) U.S. Cl. CPC B29D 30/54; B24B 5/366; B29D 2030/546; B25J 11/0065; B29D 2030/541; B24B 49/04

(57) ABSTRACT

Tire-buffing system constituted by a robotic arm (1) with angular interpolation movements with the aim of providing a modular machine capable of allowing greater amplitude of movements. The range of the movement is particularly optimized on the part of the scraping tool (5) which is installed at the end of a robotized arm (1). The buffing system is controlled via a control panel including a controller and the robotic arm is provided with at least three articulations (2) (3) (4) and two arms (12) (13) to approach automatically towards a tire to be buffed. Said tire (7) (8) (9) is supported by a rotary mandrel (6) (10) fixed independently of the robotic arm.

### CROSS REFERENCE TO RELATED APPLICATION

This application is a continuation-in-part applications and claims the benefit of and takes priority from U.S. patent application Ser. No. 14/386,858 filed on Sep. 22, 2014, which is an application for entry into the National Phase for International Application No. PCT/BR2013/000070 having an international filing date of Mar. 8, 2013, and from which priority is claimed under all applicable sections of Title 35 of the United States Code including, but not limited to, Sections 120, 363, and 365(c), and which in turn claims priority under 35 USC 119 to Brazilian Patent Application No. 10 2012 006723 4 filed on Mar. 26, 2012, the contents of which are herein incorporated by reference.

### TECHNICAL FIELD

Generally, this invention belongs to the field of tires, and more specifically concerns a system for buffing tires carried out by a robotic arm capable of carrying out angular interpolation movements.

### PRIOR ART

Devices for remolding tires in which the tire is generally arranged vertically on a rotary, translatively fixed mandrel, are known from the prior art. The tools currently used to some steps of the remolding tires processes have a buffer that carries out the rough buffing of the tire with axial and radial movements. The known devices generally are linear tables having spindles, linear guides, and cylindrical guides responsible for the movement of the buffing device. As proposed in U.S. Pat. No. 6,251,204—“Tire retreating machine”, wherein the mandrel supporting the tire to be processed is affixed on a first cart guided on rails, and the tools are coupled to a second cart, also on rails, which are orientated parallel to the rotational axis of the mandrel. About this kind of technology, we can verify the limited movements performed by the machine, having in mind that the tool is able to make only linear movements.

Generally, these devices already known in the prior art, as seen in the Australian patent document n. AU1528470, carry out movements bringing the tire nearer to or farther from the axis of the mandrel, as well as radial movements of the buffing device via guide rails. Additionally, the model proposed by the American patent n. U.S. Pat. No. 7,040,371—“Tire buffing apparatus” also illustrates these typical devices, in which the movements occur on perpendicular axes by means of parallel guides actuated by a spherical spindle. The selected tool may rotate around the vertical axis, and a control unit may monitor an operational parameter of the device, adjusting the functional characteristics of the buffing device and the support of the tire being processed. The device may be operated by a control station via an interface with the control unit. The type of system presented in the afore-mentioned patents has the disadvantage of premature wear of the linear guides, and cylindrical guides caused by the contamination of these components with rubber particles and dust resulting from the tire buffing process.

Some devices using the concept of linear tables also have problems accompanying the change in dimension of the tire given that they are not structured to support a tire of greater weight and size, which results in vibration and stability issues. The technology described in the Brazilian patent n. P10102947-9—“Máquina destinada à recapagem de Pneus”, which also uses the concept of linear tables, proposes a scalable solution for this type of problem, having at least two associated structures, each of which has guide rails responsible for the movement of the structures, and using two motors to actuate them. The guide rails of the first structure, which supports the tire, must be arranged on the rotational axis of the mandrel and symmetrically related to the vertical plane containing this axis. There is no risk of deformation or vibration of the mandrel due to the high weight of a tire, because its center of mass is maintained on a single, axis, and because the provision of symmetrical rails ensures stability on the line of the center of mass. The invention further allows for the use of a third structure arranged on the opposite side of the buffer. Because the structures are heavy, high-power motors are required to move them, and a third cart must be used, resulting in the use of a third motor, which results in greater energy consumption and an unattractive cost-benefit ratio of the system proposed by the model.

In the end, the American Patent n. US2012/0016522—“Process and machine for identification and working of defects on used tires”, in name of Leornardo Cappuccini, may also be cited. The document describes a machine used to an automatic process for the identification and working of defects. An anthropomorphic robot with three scalable joints performs said process. However, the document only requests a process capable to identify and make some minor repairs in the tires after the buffing tire procedure, because of the structure of the proposed machine. Said machine has limited movements, since its three scalable joints are disposed directly on the extremities of each module. Therefore, the machine cannot carry out wide movements, adapting the system for any size of pneumatic tires. Furthermore, this kind of machine disclosed in the prior art is not prepared to carry out movements with the same workforce required in the previous steps of buffing rubber in pneumatic tires, as the present invention proposes.

### Novel Aspects and Objectives of the Invention

In order to address the disadvantages known from the prior art, this invention discloses a robotic arm for the buffing of tires, which establishes the trajectory of the movements of the rough buffing by means of articulated arms that are actuated automatically, with at least three articulations supported on pillow blocks. The articulated arms allow for unlimited movement of the tool to be used by the system at much higher speed and with much greater precision, allowing widely varied combinations of shapes and profiles to be processed.

The invention proposed seeks to provide a scalable device capable of allowing for a greater range of movements of the tool incorporated into the system. By increasing the range of movements, the robotic arm is able to act on various tires positioned separately, thus reducing the total operational cycle time and the number of starts of the main motor of the buffing tool, which considerably reduces the energy consumption of the process and provides an attractive cost-benefit ratio to the user.

The invention proposed also relates to a method of buffing multiple tires using the above-mentioned robotic arm and at least one tire placed independently on a rotary mandrel around the said robotic arm. Said method discloses the movement to be performed by the arm toward the tire to be buffed, the variables to be consider in calculations as well as the possible automatic change of the robotic arm's position when the said tire is completely buffed to another tire to be buffed or to a predetermined initial position of the robotic arm.

The use of the robotic arm eliminates the need for linear tables, allowing for the elimination of the linear guides, cylindrical guides present in the conventional tire-buffing devices. Without these items, the device does not require periodic Iubrification of the components, and it is thus ecofriendly. The robotic arm is characterized by angular movements allowing for smaller or larger tire profiles, and further has the feature of accelerating the movement of the buffing tool, primarily displacing movements in which the tool does not touch the tire. This also results in a reduction in the buffing time, even in assemblies operating with only one tire.

Additionally, the robotic arm disclosed may also be designed in various sizes in order to work with various pneumatic tire sizes available on the market, e.g., passenger automobile tires, motorcycle tires, lorry tires, off-road/agricultural/OTR tires, etc., and allows for a more compact solution that is more space-efficient when working on larger tires.

### DESCRIPTION OF ATTACHED DRAWINGS

For better understanding and execution of the invention by persons skilled in the art, the invention will be described clearly, concisely, and adequately by reference to the attached drawings listed below, which illustrate and support it:

FIG. 1 is a perspective view of the robotic arm.

FIG. 2 is a perspective view of the robotic arm.

FIG. 3 is a side view of the tire-buffing system having a rotary mandrel system.

FIG. 4 is a perspective view of the tire-buffing system having a rotary mandrel system.

FIG. 5 is a perspective view of the tire-buffing system having a group of plates for affixing the tire.

FIG. 6 is a side view of the tire-buffing system having a group of plates for affixing the tire.

FIG. 7 shows the robotic arm carrying out the buffing process on three tires.

FIG. 8 shows the robotic arm carrying out the buffing process on two tires.

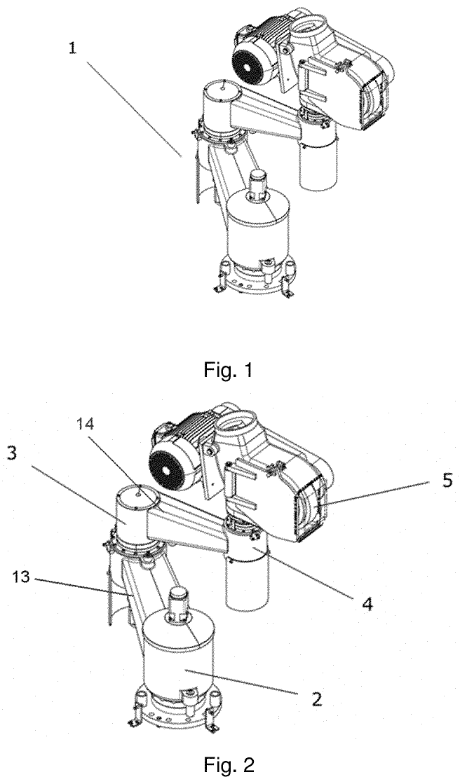

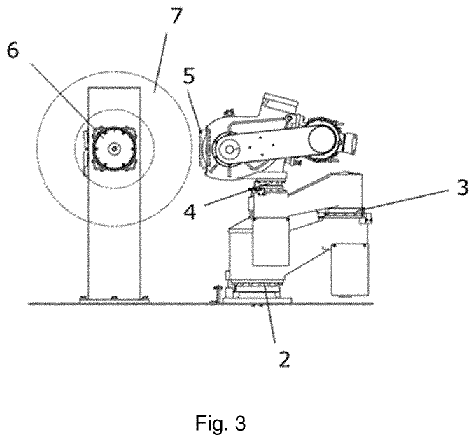

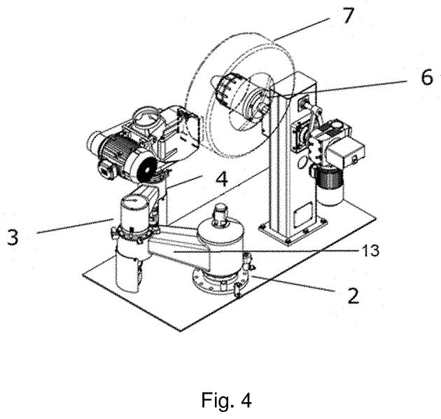

### DETAILED DESCRIPTION OF THE INVENTION

As can be seen from the attached drawings, the arrangement of the parts of the system for retreading tires disclosed herein includes a least on rotary mandrel (6) for supporting at least one tire (7, 8, 9) for being processed. The system further includes of at least one robotic arm (1), actuated automatically and controlled by software via a control panel, having at least 3 joints (2) (3) (4) and a selected tool (5).

Said rotary mandrel (6) is placed and may be actuated independently of the automatic robotic arm (1). For example, a controller is configurate, based on the acquired information of the system or a manual input of an operator, to start the rotation of one tire in the same time that the controller orientates the robotic arm to the tire to be worked.

The system for buffing tires also includes means for identifying a position of at least one tire (7, 8, 9) and means for identifying the position of the automatic robotic arm (1), not shown in figures, in order to automatically determinate via a controller the movements to be performed by the automatic robotic arm (1) for buffing a tire.

Said controller, based on the position of the tire (7, 8, 9) provided by the means for identifying the position of the tire (A) is configured to correlate this position of the tire (A) with the position of the robotic arm (1) provided by the means for identifying the position of robotic arm (B) and determine by interpolation the route of approaching of the automatic robotic arm (1) toward to the tires (7, 8, 9). Alternatively, the position of the tires can be imputed manually by an operator using a control panel. No limitation of the number of tires shall be made.

In one further embodiment, the system for buffing tires may present also means for identifying the height and width of the tire (C) to be buffed. This acquired information is used to define the amount of surface to be buffed. For example, different tires may present different wearing due to use and these information of height and width of the worn tire delimitate how far the buffing tool can remove the rubber in the said tire. Examples of means for identifying the height and width of the tire (C) are not limited to laser sensor, infrared sensor, movable touching sensors, guiding pads, etc. In a preferred embodiment, a laser sensor is placed above the rotating tire to measure the height/diameter of the tire or its tread. This information is sent to the controller that correlates this information with the other measures of the system and decides when the buffing is finished, when is time to buff the tire/tread laterals or finish the buffing process and move the robotic arm (1) to another tire or return it to its initial position.

In another embodiment, the system for buffing tires further presents means for identifying the thickness of the tire (C) or its tire's tread to be buffed. In a preferred configuration, these means to measure the thickness of the tire or tire treads are inductive sensors. In one preferred embodiment, the inductive sensor may be a inductive sensor placed on the top of the supporting structure of the tire, which sends the measure of the tire tread in real time to the controller. The controller then analyses the thickness of the working tread, sending a command to the robotic arm (1) to continue buffing, stop buffing, moving the selected tool (5) to buff tread to the tire laterals or finish the work in the said tire. In case the work on the profile of the said tire is finished, the controller may send a command to the robotic arm to move to another tire or to return to its initial position.

These means for identifying the positions (A, B) and dimensions of the tires (C) may be placed anywhere of the system. In one embodiment, said means for identifying the position of the tire (A) are placed in the structure supporting the mandrel (6) and said means for identifying the position of the robotic arm (A) are embedded into the robotic arm (1). Alternatively, said means for identifying the position of the tire (A) may be placed in the selected tool (5) or in any structure supporting any parts of the buffing system.

In another embodiment, the measures of the tire to be buffed can be inserted manually by an operator using a control panel or a human machine interface (HMI). From that point, the controller of the buffing system may calculate how much of the tire's rubber should be removed and sent this information to the robotic arm (1).

According to preset instructions placed by an operator for the work to be done or according to preset instructions of buffing specific tires (size or manufacturer, for example), the buffing system may place the selected tool in front of the tire profile to be buffed and decide the directions that the buffing are made. For example, the buffing process may start in the center of the tire, moving towards the right sidewall of the tire, and later starts again in the middle of the tread moving to the left sidewall of the tire by interpolation. Optionally, the buffing process may start from one sidewall to the other sidewall of the tire.

Once the buffing process starts, no operator is requested to move the robotic arm (1) or any other parts of the buffing system. According to the preset instructions, the mandrel starts rotating when of the approaching of the robotic arm, the robotic arm performs the buffing and after the profile of the tire is finished, the controller automatically sends a command to retract the robotic arm (1) from the finished tire, to stop the rotation of the mandrel having the finished tire and to move the robotic arm (1) to another tire to be buff or return it to its initial position.

The robotic arm (1) comprises a first horizontal arm (13) disposed horizontally and connecting the axis (fixed to a planar surface, such as the ground) with the first joint (2) to the axis with the second joint (3); an second horizontal arm (14) disposed horizontally and connecting the axis with the second joint (3) to axis with the third joint (4); and a selected tool (5) to perform the desired tire activity engaged at the end of the second horizontal arm (14) on the axis with the third joint (4). Therefore, is considerable that the presence of the first horizontal arm (13) and the second horizontal arm (14) disposed in the equipment provide degrees of freedom with greater range of movement to the horizontal displacement of the machine.

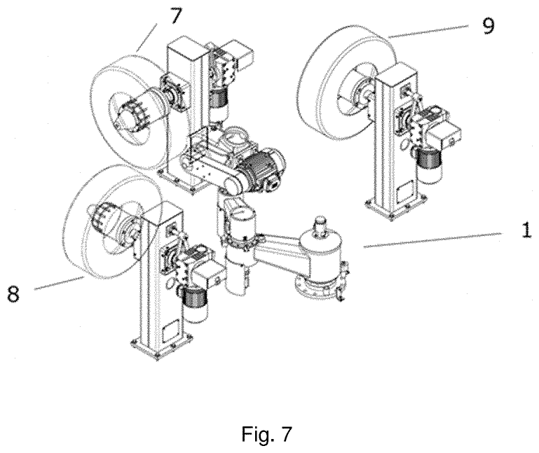

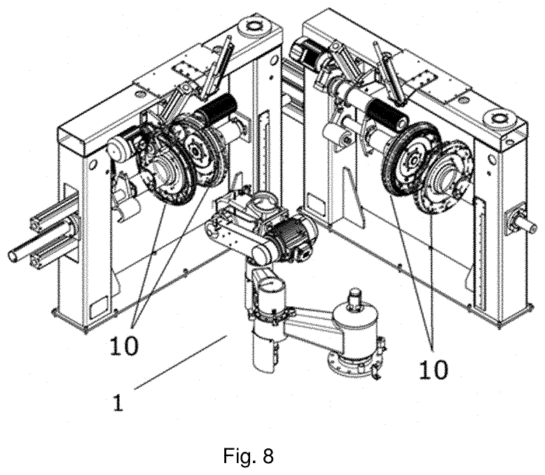

Furthermore, the joints (2), (3), (4) allow for a greater range of motion of the tool coupled to the system. Thus, the robotic arm (1) can carry out angular interpolation movements and can thus better adapt to the contour of the tire (7). Having in mind that the proposed machine comprises these joints (2) (3) (4) which perform the rotational movement in the horizontal plan, this technology is able to realize movements in 360 degrees horizontally. Thus, the robotic arm (1) is able to buff pneumatic tires and, when the first tire (7) is ready, automatically the system may be configured to work on a second tire (8) and then on a third tire (9) or more. In short, because of the equipment allows for a greater range of movement, the robotic arm (1) may work on various tires (7), (8), (9) separately, reducing the cycle time and the number of times the main motor of the tool is started. FIG. 7 illustrates this kind of operation, when the robotic arm (1) proposed in the present document works on three tires (7) (8) (9).

The robotic arm (1) further allows the system to perform the steps involved in buffing. Moreover, the robotic arm (1) is configured to support the traction forces, necessary to perform the steps the buffing pneumatic tires (7) (8) (9).

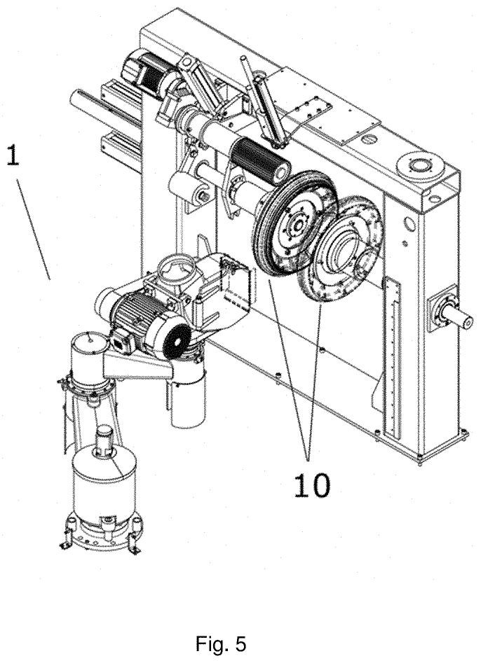

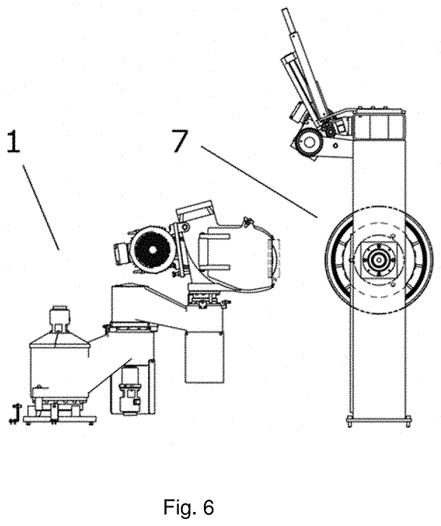

FIG. 5 and FIG. 6 illustrate different types of systems that may be used to accomplish the support of the tire (7). Thus, the system is independent of the type of mandrel supporting the tire (7) because of the tire support and the robotic arm (1) are independent. Thus, both a system with a rotary mandrel (6) and a tire fixation using plates (10), for example, or amongst others, may be used. The only requirement is that the mandrel support has to be rotary to realize the movement of the pneumatic tire (7).

In one embodiment, the controller of the system is configured to buff the desired one tire (7, 8 or 9). In this case, the operator starts the system, indicating at least one mandrel (6) having a tire to be buffed, and then the controller, based on the position of the tire (7, 8 or 9) send a command to the robotic arm (1) in order to move the selected tool (5) toward the face of the tire, preferably on a vertical position when compared to the ground, having a certain distance from the tread. The controller, based on the tread width and height, send a command to the selected tool (5) to start buffing the tire until a preset thickness of the tire or tire's tread. Such information of desired thickness to the tread in correlation with the width and height of the tire also permit that selected tool (5) to buff the tire laterally, interpolating the perimeter of the tread in order to achieve a smooth surface of the tread buffed. After the buffing of the tire finishes, the robotic arm may return to its original position or move to another tire.

When the operator has set the system to buff more than one tire (6, 7 or 8), the controller, based on the actual position of the robotic arm and the position of the second tire to be worked, will send a command to the robotic arm (1) in order to move the first horizontal arm (12) and the second horizontal arm (13) which holds the selected tool (5), by means of turning the joints (2) (3) (4), retracting or expanding them in order to get close to the second tire to be worked. Following the same principles of the previous embodiment, the selected tool will approach to the second tire to be buffed and starts the buffing until the preset thickness of the tire or tire's tread is achieved.

When interpolating the curvature of the tire in order to achieve the desired thickness of the tire, the selected tool (5) for buffing tires will have its speed modulated by the friction exerted by the buffing process, therefore it may increase the speed of the selected tool (5) in order to buff the side of the tire faster. In the same way, the controller will send a command to the selected tool (5) to slow down its rotation or still, increase or stop the rotation of the selected tool (5) in order to move to the other side of the tread/tire and perform the same lateral/interpolation buffing.

In case more than one tire is selected to be buffed, after finishing the work in one tire, for example tire (7), the controller will send a command to the robotic arm (1) to retract itself and turn the joints and first and second horizontal arms (12) and (13) to a position close to the second tire to be buff and so on. After the work on all tires finishes, the robotic arm (1) may return to its original position.

In one embodiment, each working station having a mandrel (6) with a tire to be buff may hold different types of tires, therefore the preset measures of buffing profile may vary from one station to other, depending on the type of each tire (7, 8 or 9). Accordingly, the time of the buffing process and the velocity of the selected tool may vary due to tire's specifications.

### Examples of the Invention

In one embodiment, the system for buffing tires comprises:
a rotary mandrel (6) (10) for supporting at least one tire (7) (8) (9);
means for identifying a position of the at least one tire (7) (8) (9);
an automatic robotic arm (1) containing at least three moveable joints (2) (3) (4) that performs angular interpolation movements, wherein the robotic arm (1) comprises:
   a first horizontal arm (13) configured to move in a first arm horizontal plane in relation to the ground connecting the axis with a first moveable joint (2) to an axis with a second moveable joint (3);
   a second horizontal arm (14) configured to move in a second arm horizontal plane in relation to the ground connecting the axis with the second moveable joint (3) to an axis with a third moveable joint (4); and
   a selected tool (5) engaged at an end of the second horizontal arm on the axis of the third moveable joint (4), said selected tool configured for buffing tires;
   a control panel provided with a software that orientates the approaching of the automatic robotic arm (1) to the at least one tire (7) (8) (9) based on the identified position of the said tire;
wherein the first moveable joint (2) of the robotic arm (1) is fixed independently of the rotary mandrel (6) (10), wherein the robotic arm (1) is capable of rotating three hundred sixty degrees around the axis of the first moveable joint (2) and automatically placing the selected tool (5) near one of the tires (7) (8) (9) placed within a reaching range of the robotic arm (1); and wherein the software, based on the contour of the tire to be buffed, perform angular interpolations to orientate the movement of the selected tool (5) and the horizontal arms (13,14) around the said tire.

In another embodiment, the system for buffing tires according to the previous embodiment presents the robotic arm (1) configured to buffer rubber from tires that are positioned separately (7), (8), (9).

In another embodiment, the system for buffing tires according to the previous embodiment, further comprises means for identifying the height and width of the at least one tire (7) (8) (9) or its tread.

In one embodiment, those means for identifying the height or the width of the at least one tire (7) (8) (9) or its tread are laser sensors.

The system for buffing tires according to the previous embodiments further comprises means for identifying the thickness of the at least one tire (7) (8) (9) or its tread.

In one additional embodiment, said means for identifying the thickness of the at least one tire (7) (8) (9) or its tread are inductive sensors.

A method for automatically buffer at least one tire using the previous system is disclosed having the following steps:
a. insert at least one tire to be buffed in a rotary mandrel;
b. identify, in a control panel of the said system, at least one tire to be buffed;
c. provide a position of a at least one tire to the controller of said system;
d. provide a position of the robotic arm to the said controller;
wherein the position of said tire identified in the control panel is processed by the controller, said controller defining the sequence of movements of the robotic arm (1) to approach to the said at least one tire based on the positions c) and d); wherein the controller actuates the robotic arm (1) to approach the at least one tire by moving first horizontal arm and the second horizontal arm, until a selected tool engaged at an end of the second horizontal arm faces the at least one tire to be buffed; wherein the selected tool starts to buff the at least one tire; and wherein after finishing the buffing of the at least one tire, the robotic arm moves to its initial position or to a position of a second tire and starts the buffing process.

An additional embodiment of the previous method further comprises the steps of:
e. provide measurement of height and width of the at least one tire to the said controller;
f. provide measurement of thickness of the at least one tire tread to the said controller; and
g. provide, to the said controller, a final measurement of thickness of the first tire tread to be achieved.

Another embodiment of the previous method states that the controller, based measurements of e), f) and g), defines the amount of rubber to be buffed from the tire tread and the speed of the selected tool.

In one further embodiment of this method, said controller, based measurements of e), f) and g), defines a interpolation calculation for the selected tool to buffer a lateral of the at least one tire, wherein when the buffering of the first side of the at least one tire is finished, the robotic arm automatically moves to the second side of the at least one tire.

Additionally, in one embodiment, the method predicts that when the buffering of at least one tire is finished, the robotic arm is driven by the controller to the second tire to be buffed.

Finally, in one embodiment, the previous method states that when the buffering of at least one tire is finished, the robotic arm returns to its initial position.

The number of tires to be buffed by the robotic arm are not limited by any means, as well as the controller capacity of handling the positioning and measurement of the tires.

The drawings and the description do not limit the embodiments of the invention proposed herein, but merely illustrate and facilitate an understanding of the conceptual innovations disclosed in this invention; as such, the descriptions and drawings must be considered as illustrations and not limitations. There may be other equivalent or analogous embodiments of the invention disclosed here in that do not leave the scope of the invention.

Described herein is a specific, original system for retreading tires, capable of substantially improving its use, which is novel, inventive, sufficiently disclosed, and industrially applicable, and accordingly meets all the essential requirements for the grant of the patent sought.

What is claimed is:

1. A system for buffing tires comprising:
a rotary mandrel (6) (10) for supporting at least one tire (7) (8) (9);
means for identifying a position of the at least one tire (7) (8) (9);
an automatic robotic arm (1) containing at least three moveable joints (2) (3) (4) that performs angular interpolation movements, wherein the robotic arm (1) comprises:
a first horizontal arm (13) configured to move in a first arm horizontal plane in relation to the ground connecting the axis with a first moveable joint (2) to an axis with a second moveable joint (3);
a second horizontal arm (14) configured to move in a second arm horizontal plane in relation to the ground connecting the axis with the second moveable joint (3) to an axis with a third moveable joint (4); and
a selected tool (5) engaged at an end of the second horizontal arm on the axis of the third moveable joint (4), said selected tool configured for buffing tires;
a control panel provided with a software that orientates the approaching of the automatic robotic arm (1) to the at least one tire (7) (8) (9) based on the identified position of the said tire;
wherein the first moveable joint (2) of the robotic arm (1) is fixed independently of the rotary mandrel (6) (10);
wherein the robotic arm (1) is capable of rotating three hundred sixty degrees around the axis of the first moveable joint (2) and automatically placing the selected tool (5) near one of the tires (7) (8) (9) placed within a reaching range of the robotic arm (1)
wherein the software, based on the contour of the tire to be buffed, perform angular interpolations to orientate the movement of the selected tool (5) and the horizontal arms (13,14) around the said tire.

2. The system for buffing tires according to claim 1, wherein the robotic arm (1) is configured to buff rubber from tires that are positioned separately (7), (8), (9).

3. The system for buffing tires according to claim 1, wherein said system further comprises means for identifying the height and width of the at least one tire (7) (8) (9) or its tread.

4. The system for buffing tires according to claim 3, wherein means for identifying the height or the width of the at least one tire (7) (8) (9) or its tread are laser sensors.

5. The system for buffing tires according to claim 1, wherein said system further comprises means for identifying the thickness of the at least one tire (7) (8) (9) or its tread.

6. The system for buffing tires according to claim 5, wherein said means for identifying the thickness of the at least one tire (7) (8) (9) or its tread are inductive sensors.

7. The system for buffing tires according to claim 1, wherein the second horizontal arm (14) further presents overlapping movement over the first horizontal arm (13).

8. A method for automatically buffing at least one tire utilizing the system of claim 1, said method comprising the steps of:
a. inserting at least one tire to be buffed in a rotary mandrel;
b. identifying, in a control panel of the said system, at least one tire to be buffed;
c. providing a position of a at least one tire to the controller of said system;
d. providing a position of the robotic arm to the said controller;
wherein the position of said tire identified in the control panel is processed by the controller, said controller defining the sequence of movements of the robotic arm (1) to approach to the said at least one tire based on the positions c) and d);
wherein the controller actuates the robotic arm (1) to approach the at least one tire by moving first horizontal arm and the second horizontal arm, until a selected tool engaged at an end of the second horizontal arm faces the at least one tire to be buffed;
wherein the selected tool starts to buff the at least one tire; and
wherein after finishing the buffing of the at least one tire, the robotic arm moves to its initial position or to a position of a second tire and starts the buffing process.

9. The method of claim 8, wherein said method further comprises the steps of:
e. providing a measurement of height and width of the at least one tire to the said controller;
f. providing a measurement of thickness of the at least one tire tread to the said controller; and
g. providing, to the said controller, a final measurement of thickness of the first tire tread to be achieved.

10. The method of claim 9, wherein said controller, based measurements of e), f) and g), defines the amount of rubber to be buffed from the tire tread and the speed of the selected tool.

11. The method of claim 9 wherein said controller, based measurements of e), f) and g), defines a interpolation calculation for the selected tool to buffer a sidewall of the at least one tire, wherein when the buffing of the first sidewall of the at least one tire is finished, the robotic arm automatically moves towards the second sidewall of the at least one tire and starts buffing it.

12. The method of claim 10 wherein when the buffering of at least one tire is finished, the robotic arm is driven by the controller to the second tire to be buffed.

13. The method of claim 10 wherein when the buffering of at least one tire is finished, the robotic arm returns to its initial position.
